(19) United States
(12) Patent Application Publication
(10) Pub. No.: US 2004/0154273 A1
(43) Pub. Date: Aug. 12, 2004

(54) Air return grille

(76) Inventor: James P. Stephan, Monroe, LA (US)

Correspondence Address: John M. Harrison, 2139 E. Bert Kouns, Shreveport, LA, 71105, US

(21) Appl. No.: 10/699,017

(22) Filed: Nov. 3, 2003

Related U.S. Application Data
(60) Provisional application No. 60/445,577, filed on Feb. 10, 2003.

(51) Int. Cl. B01D 46/00

(52) U.S. Cl. 55/495

(57) ABSTRACT

An air return grille which may be constructed of wood or other materials and includes a frame having side frame members closed by top and bottom frame members, the side frame members having multiple, angled slat seats therein for receiving the ends of corresponding spaced-apart, parallel slats. One or more centerbar is spaced-apart between the side frame members and each centerbar is fitted with multiple, angled slat openings to receive and support the slats in the center portion of the frame. Trim strips are provided on both sides and the top and the bottom of the frame for trimming the frame around the perimeter of an air return opening in a wall. Frame seating brackets are provided on the side frame members for removably engaging seating screws driven into the vertically-oriented, parallel studs that frame the mount opening, for removably seating the frame in the mount opening. Filter retainer wires are removably and adjustably mounted across the corners of the frame by means of retainer wire clips and are adapted to selectively receive and mount one or two filters rearwardly of the frame.

### CROSS-REFERENCE TO RELATED APPLICATIONS

This application claims the benefit of and incorporates by reference prior filed copending U.S. Provisional Application Serial No. 60/445,577, Filed Feb. 10, 2003.

### SUMMARY OF THE INVENTION

An air return grille which is typically constructed of wood in a preferred embodiment and includes a frame defined by parallel side frame members, or stiles, a top frame member and a bottom frame member (rails) which are typically glued and stapled together. The side frame members are fitted with spaced-apart, angular slat seats for accommodating the ends of multiple, parallel slats that are supported in the center of the frame by one or more centerbars. The centerbars are provided with parallel, angled slat openings that correspond to the respective slat seats, for accommodating the slats in a slip-fit to facilitate optimum support of the slats and the number of centerbars used is determined by the distance between the side frame members in the grille frame. The centerbar or centerbars serve to minimize warping of the slats and also facilitate the use of small slats to allow greater voids between the slats and optimize the flow of air through the air return grille. Trim strips are provided around the periphery of the grille frame to frame the air return opening in a wall in which the grille frame is removably seated.

In a preferred embodiment seating screws are driven into the vertical, parallel studs spanning the air return opening in which the frame is seated and the frame is fitted with corresponding spring-action seating brackets that engage the respective seating screws and removably seat the air return grille in the air return opening in a friction-fit. In another preferred embodiment of the invention the retainer wire clips are attached to the frame near at least two opposite corners, and preferably, at each corner thereof and removably accommodate corresponding shaped, removable, filter retainer wires to facilitate mounting one or two air filters on the frame. Each of the fixed retainer wire clips is provided with a pair of spaced-apart leg retainers for selectively receiving corresponding leg extensions terminating the filter wire legs, to accommodate one or two filters, as desired. In yet another preferred embodiment of the invention the ends of the top and bottom frame members are mortised to accommodate the side frame members, the top and bottom frame members are also mortised to receive the respective ends of the centerbar or centerbars and the trim strips are longitudinally mortised to fit corresponding longitudinal tenons shaped in the frame members and facilitate optimum strength in the glued grille frame.

### BRIEF DESCRIPTION OF THE DRAWINGS

The invention will be better understood by reference to the accompanying drawings, wherein:

FIG. 1 is a perspective view of a preferred embodiment the air return grille of this invention having two centerbars and seated in an air return opening provided in a wall;

FIG. 2 is a perspective view of the wall and grille frame illustrated in FIG. 1, with the grille frame spaced from the wall, more particularly illustrating preferred seating screws driven into parallel studs framing the mount opening, for removably seating the air return grille in the air return opening;

FIG. 3 is a rear perspective view of the air return grille illustrated in FIGS. 1 and 2, more particularly illustrating mounting of a single air filter on the back side of the grille frame using the respective removable filter retainers positioned in a first location in the corresponding leg retainers of the retainer clips;

FIG. 4 is a sectional view taken along line 4-4 of the air return grille illustrated in FIG. 3, more particularly illustrating a preferred mortise joint between the respective trim strips and the corresponding frame members, as well as a preferred mounting of the respective seating brackets and seating screws for removably retaining the air return grille in the air return opening of a wall, as illustrated in FIG. 1;

FIG. 5 is a sectional view taken along line 5-5 of the air return grille illustrated in FIG. 3, more particularly illustrating a preferred mounting of the respective retainer clips on the grille frame to receive the corresponding leg extensions of the filter retainer and accommodate a single filter as illustrated in FIG. 3;

FIG. 6 is a perspective view, partially in section, of one corner of the grille frame, more particularly illustrating insertion of the two leg extensions of a removable filter retainer in a second location in the respective leg retainers of the corresponding retainer clips, to accommodate two filters on the grille frame;

FIG. 7 is a perspective view, partially in section, of one corner of a second preferred embodiment of the air return grille of this invention with the filter removed, more particularly illustrating a single centerbar equally spaced between the corresponding parallel side frame members in the grille frame; and

FIG. 8 is an exploded view of the air return grille illustrated in FIGS. 1 and 2.

### DESCRIPTION OF THE PREFERRED EMBODIMENTS

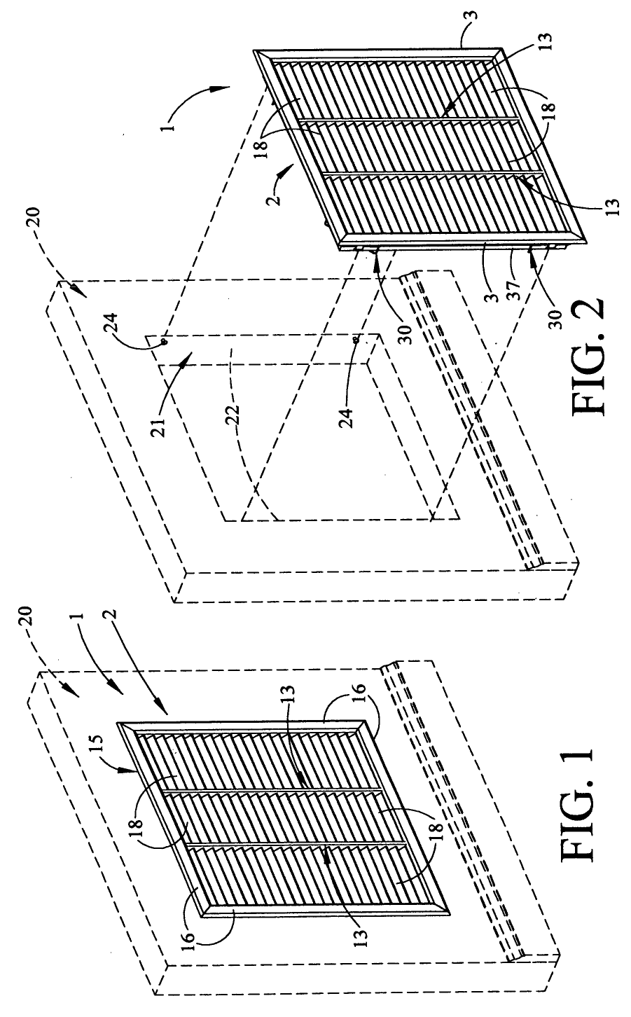

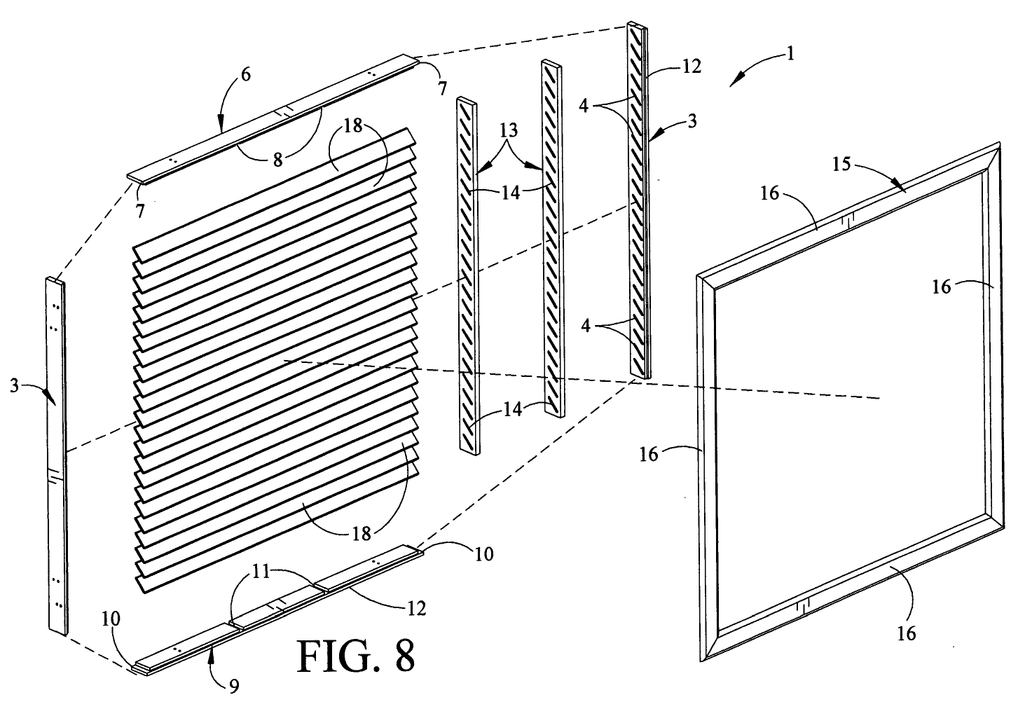

Referring initially to FIGS. 1, 2, 4, 5 and 8 of the drawings the air return grille of this invention is preferably constructed of wood and is identified by reference numeral 1. The air return grille 1 includes a grille frame 2 of selected size, defined by parallel side frame members (stiles) 3, each fitted with inwardly-facing, angular, spaced-apart and parallel side frame member slat seats 4 and closed by a top frame member 6 and a bottom frame member 9 (rails), which frame members are typically glued and stapled together, as illustrated in FIG. 8. The grille frame 2 is bordered by a trim 15 which includes trim strips 16 that skirt each of the side frame members 3, the top frame member 6 and the bottom frame member 9 and typically connect at mitered joints. In a most preferred embodiment of the invention the components of the grille frame 2 are constructed of wood and the trim strips 16 are each characterized by a longitudinal trim strip mortise 17 that engages a corresponding longitudinal frame member tenon 12, provided in each of the side frame members 3, the top frame members 6 and the bottom frame member 9 (FIGS. 4 and 5). In another preferred embodiment a bottom frame member end mortise 10 is provided on each end of the bottom frame member 9 and one or more bottom frame member interior mortises 11 are also provided in the bottom frame member 9 to receive the bottom ends of the side frame members 3 and the bottom end or ends of one or more centerbars 13, respectively (FIG. 8). Furthermore, a top frame member end mortise 7 is provided in each end of the top frame member 6 and one or more top frame member interior mortises 8 are also provided in the top frame member 6, to receive the tops of the two side frame members 3 and the tops of one or more of the centerbars 13, respectively, as further illustrated in FIG. 8 of the drawings. Each of the centerbars 13 is further provided with angular, parallel, spaced-apart centerbar slat openings 14, each angle of which corresponds to the angle of the corresponding side frame member slat seats 4, to accommodate in a slip-fit, multiple slats 18 of selected width and thickness, extending from the corresponding side frame member slat seats 4, as further illustrated in FIGS. 1, 2 and 8 of the drawings.

Referring again to FIG. 2 of the drawings a wall 20 (illustrated in phantom) is provided with an air return opening 21 (also in phantom) that opens into a return air duct (not illustrated) and is slightly larger than the grille frame 2. Four seating screws 24 are typically driven into the parallel, spaced-apart studs 22 (further illustrated in phantom) that frame the sides of the air return opening 21, as further illustrated in FIG. 2. The air return grille 1 is then removably seated in the air return opening 21 in the wall 20 in a friction-fit, as hereinafter described, with the trim 15 closing the perimeter opening around the installed grille frame 2, as illustrated in FIG. 1.

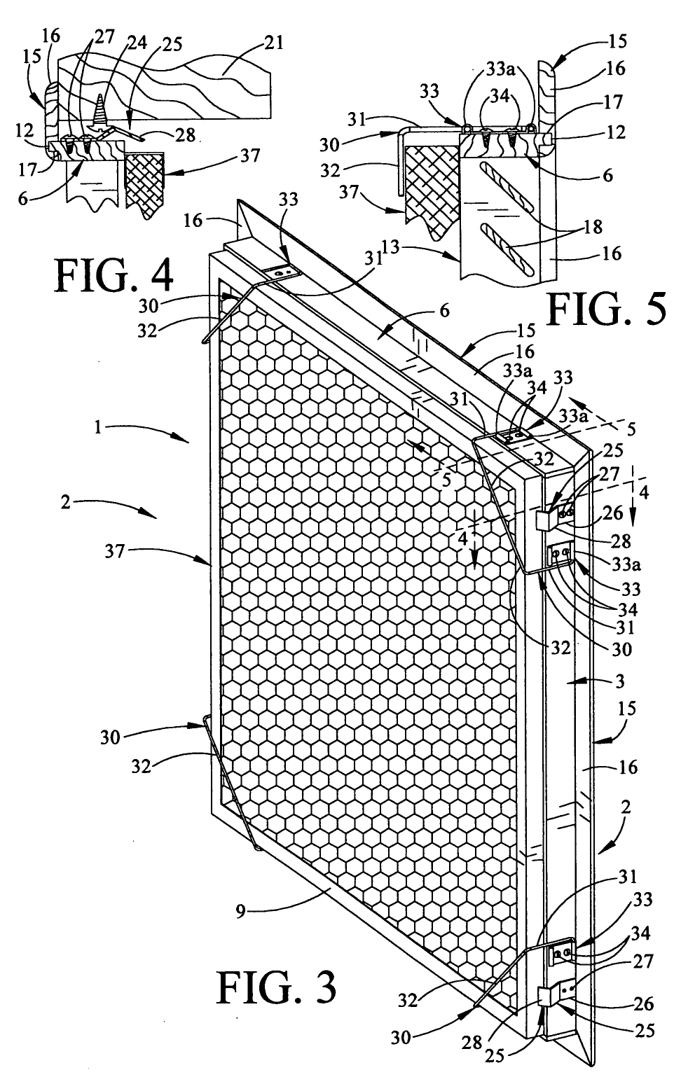

Referring now to FIGS. 3-5 and 7 of the drawings in a first preferred embodiment of the invention a single air filter 37 is seated on the back side of the grille frame 2 of the air return grille 1 and is typically removably so positioned by means of four removable, shaped wire filter retainers 30, as illustrated in FIG. 3. Alternatively, a pair of the wire filter retainers 30 can be used on opposite corners of the grille frame 2 to achieve the same result. Under circumstances where the single air filter 37 is secured in place as illustrated in FIG. 3, each of the leg extensions 3 la of the retainer legs 31 in each of the filter retainers 30 (FIG. 7) is seated in a corresponding inverted U-shaped leg retainer 33a of a retainer clip 33, each of which receiving leg retainer 33a is located farthest from the filter 37, as further illustrated in FIGS. 3 and 5. Accordingly, referring again to FIGS. 3, 5 and 7 of the drawings each of the retainer clips 33, including the spaced-apart, inverted U-shaped leg retainers 33a, is attached to the corresponding side frame members 3, top frame member 6 and bottom frame member 9 near the corner intersections thereof, by means of retainer clip mount screws 34 that extend through corresponding retainer clip openings 35, into pilot holes 36 provided in the respective side frame members 3, top frame member 6 and bottom frame member 9, as illustrated in FIG. 7 of the drawings. In a preferred embodiment each of the filter retainers 30 are shaped to define the spaced-apart leg extensions 31a and retainer legs 31, extending from both ends of a filter leg 32 that engages the filter 37 and removably retains the filter 37 in place against the back side of the grille frame 2, as illustrated in FIG. 3. Removal of the filter 37 from the position illustrated in FIG. 3 is effected by disengaging one or both of the leg extensions 31a of the respective filter retainers 30 from the corresponding leg retainers 33a of the retainer clips 33 to free the filter 37.

Referring again to FIGS. 3, 4 and 7 of the drawings in another preferred embodiment of the invention a pair of seating brackets 25 is provided on each of the side frame members 3 by means of mount leg screws 27 that thread into corresponding pilot holes 36, as illustrated in FIG. 7. Each of the seating brackets 25 is characterized by a flat seating mount bracket leg 26, having mount leg openings 26a that accommodate a pair of mount leg screws 27 and an inverted, typically V-shaped seating bracket contact leg 28 extends from each of the respective seating bracket mount legs 26 for engaging the projecting heads of a corresponding pair of seating screws 24, driven into the parallel studs 22 that frame the air return opening 21, as illustrated in FIGS. 2 and 4 of the drawings. Accordingly, when the grille frame 2 is seated in the air return opening 21 as illustrated in FIGS. 1 and 2 of the drawings, each of the four spring-steel seating bracket contact legs 28 contacts the projecting head of a corresponding seating screw 24 in the respective studs 22, to bend and facilitate a friction-fit of the air return grille 1 in the grille mount opening 21, as illustrated in FIGS. 1 and 4. This friction-fit is effected because of the spring tension provided in each of the inverted V-shaped seating bracket contact legs 28 that first bend to accommodate the heads of the seating screws 24 as the air return grille 1 is placed in position in the air return opening 21, and then return to the original configuration, as illustrated in FIGS. 1, 2 and 4. Removal of the air return grille 1 from the air return opening 21 is typically effected by grasping the grille frame 2 and pulling outwardly to again momentarily depress the seating mount contact legs 28 away from the heads of the respective seating screws 24 and facilitate sliding of the seating mount bracket contact legs 28 over the heads of the seating screws 24.

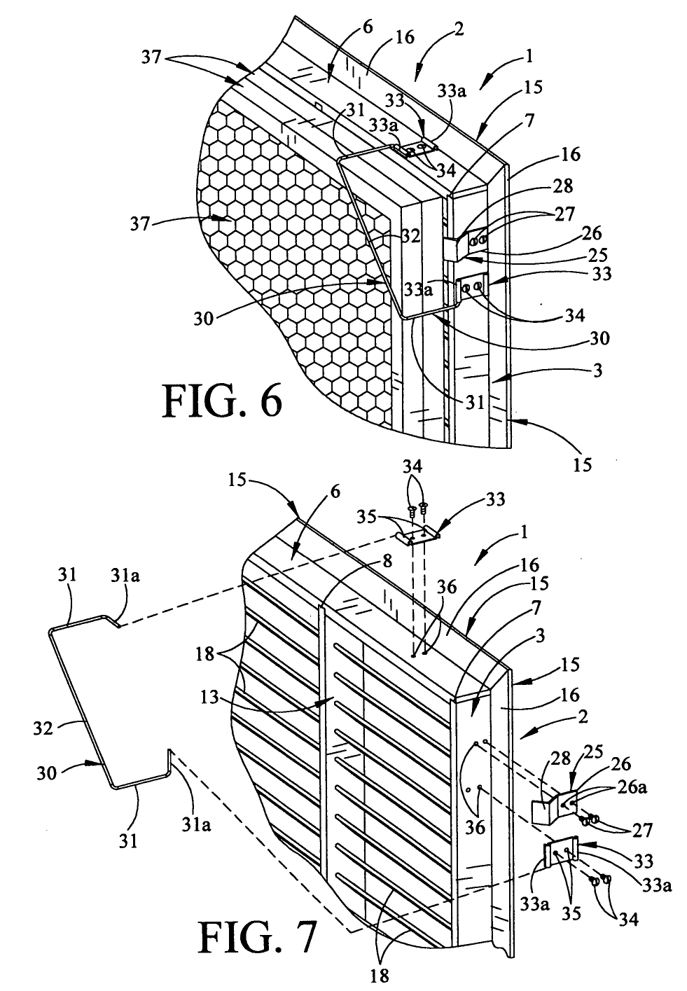

Referring now to FIGS. 6 and 7 of the drawings, under circumstances where it is desired to accommodate a single, two-inch filter 37 or pair of filters 37 against the back side of the grille frame 2, the single filter 37 or the two filters 37 can be placed on the back side of the grille frame 2 of the air return grille 1 and the shaped filter retainers 30 then positioned across at least two opposite comers of the respective filters 37, as illustrated. The respective leg extensions 31 a, extending from the retainer legs 31 of the corresponding filter retainers 30, are then inserted in the closest leg retainer 33a to the filter or filters 37, rather than in the farthest leg retainers 33a (FIG. 3), to accommodate the second filter 37 or the single two-inch filter 37. Accordingly, it will be appreciated from consideration of FIG. 6 that the retainer clip 33 is designed to accommodate both the single one-inch filter attached to the grille frame 2 of the air return grille 1 as illustrated in FIG. 3, as well as two, one-inch filters 37, or one two-inch filter 37 as illustrated in FIG. 6, depending upon the positioning of the respective leg extensions 31 a in the selected corresponding leg retainers 33a of the respective retainer clips 33.

It will be appreciated by those skilled in the art that while the air return grille 1 of this invention is preferably constructed of wood for esthetic purposes and ease of fabrication and assembly, typically using glue and staples, other materials such as fiberglass, plastic and the like, which can be molded, shaped or otherwise constructed to simulate wood, may be utilized by injection molding and other techniques known to those skilled in the art. Moreover, the air return grille of this invention can also be constructed of metal, according to techniques further understood and known by those skilled in the art. In each case, use of the centerbar(s) 13 facilitates use of smaller slats 18, the size and number of which are selected for esthetic appeal.

Furthermore, referring again to the drawings, as a general guideline, two centerbars 13 may be used where the span between the two side frame members 3 exceeds about 20 inches. Moreover, in a preferred embodiment the side frame member slat seats 4 and centerbar slat openings 14 illustrated in FIG. 8 are disposed at about a 45-degree angle when the center-to-center distance between the respective adjacent frame member slat seats 4 and centerbar slat openings 14, respectively, is about one inch. This arrangement of the parallel slats 18 facilitates optimum screening of the filter or filters 37 from view when the slats 18 are installed in the respective frame member slat seats 4 and centerbar slat openings 14 with the bottom slat edges facing downwardly and forwardly in the grille frame 2. Moreover, in a preferred embodiment the centerbar(s) 13 serve to reduce warp in the wooden slats 18 and the slats 18 are moderately loosely-to-firmly seated in a slip-fit in the centerbar slat openings 14 and the respective frame member slats 4.

While the preferred embodiments of the invention have been described above, it will be recognized and understood that various modifications may be made in the invention and the appended claims are intended to cover all such modifications which may fall within the spirit and scope of the invention.

Having described my invention with the particularity set forth above, what is claimed is:

1. An air return grille for seating in an air return opening and adapted for mounting at least one filter, said air return grille comprising a frame defined by a pair of side frame members, a top frame member spanning one end of said side frame members and a bottom frame member spanning the opposite end of said side frame members; a plurality of inwardly-facing, spaced-apart slat seats provided in said side frame members; at least one centerbar disposed between said side frame members and spanning said top frame member and said bottom frame member; a plurality of spaced-apart slat openings provided in said centerbar, said slat openings disposed in substantially coplanar relationship with corresponding ones of said slat seats in said side frame members; and a plurality of slats extending through said slat openings in said centerbar, with the ends of said slats seated in said slat seats in said side frame members.

2. The air return grille of claim 1 wherein said at least one centerbar comprises two centerbars disposed between said side frame members in spaced-apart relationship with respect to each other and engaging said top frame member and said bottom frame member.

3. The air return grille of claim 1 wherein said slat seats are disposed at a first selected angle with respect to the longitudinal axis of said side frame members and said slat openings are disposed at said first selected angle with respect to the longitudinal axis of said centerbar.

4. The air return grille of claim 3 wherein said at least one centerbar comprises two centerbars disposed between said side frame members in spaced-apart relationship with respect to each other and engaging said top frame member and said bottom frame member.

5. The air return grille of claim 1 comprising at least two filter retainers provided on said frame for receiving and mounting the filter on said frame.

6. The air return grille of claim 5 wherein said slat seats are disposed at a first selected angle with respect to the longitudinal axis of said side frame members and said slat openings are disposed at said first selected angle with respect to the longitudinal axis of said centerbar.

7. The air return grille of claim 5 wherein said at least one centerbar comprises two centerbars disposed between said side frame members in spaced-apart relationship with respect to each other and engaging said top frame member and said bottom frame member.

8. The air return grille of claim 5 wherein:
(a) said slat seats are disposed at a first selected angle with respect to the longitudinal axis of said side frame members and said slat openings are disposed at said first selected angle with respect to the longitudinal axis of said centerbar; and
(b) said at least one centerbar comprises two centerbars disposed between said side frame members in spaced-apart relationship with respect to each other and engaging said top frame member and said bottom frame member.

9. The air return grille of claim 5 comprising at least two sets of retainer clips mounted on said frame and at least one leg retainer provided on each of said retainer clips for removably receiving said filter retainers, respectively, and removably mounting the filter on said frame.

10. The air return grille of claim 9 wherein said at least one leg retainer comprises two leg retainers provided in spaced-apart relationship with respect to each other on said retainer clips, respectively, for selectively receiving said filter retainers and removably mounting the filter on said frame.

11. The air return grille of claim 9 wherein said at least one centerbar comprises two centerbars disposed between said side frame members in spaced-apart relationship with respect to each other and engaging said top frame member and said bottom frame member.

12. The air return grille of claim 9 wherein said slat seats are disposed at a first selected angle with respect to the longitudinal axis of said side frame members and said slat openings are disposed at said first selected angle with respect to the longitudinal axis of said centerbar.

13. The air return grille of claim 9 wherein:
(a) said slat seats are disposed at a first selected angle with respect to the longitudinal axis of said side frame members and said slat openings are disposed at said first selected angle with respect to the longitudinal axis of said centerbar; and
(b) said at least one centerbar comprises two centerbars disposed between said side frame members in spaced-apart relationship with respect to each other and engaging said top frame member and said bottom frame member.

14. The air return grille of claim 13 wherein said at least one leg retainer comprises two leg retainers provided in spaced-apart relationship with respect to each other on said retainer clips, respectively, for selectively receiving said filter retainers and removably mounting the filter on said frame.

15. The air return grille of claim 1 comprising at least one pair of seating brackets provided on said frame and a pair of seating screws provided in said air return opening, with said frame removably seated in said air return opening in a friction-fit, responsive to contact between said seating brackets and said seating screws.

16. The air return grille of claim 15 wherein said at least one centerbar comprises two centerbars disposed between said side frame members in spaced-apart relationship with respect to each other and engaging said top frame member and said bottom frame member.

17. The air return grille of claim 15 wherein said slat seats are disposed at a first selected angle with respect to the longitudinal axis of said side frame members and said slat openings are disposed at said first selected angle with respect to the longitudinal axis of said centerbar.

18. The air return grille of claim 15 wherein:
(a) said slat seats are disposed at a first selected angle with respect to the longitudinal axis of said side frame members and said slat openings are disposed at said first selected angle with respect to the longitudinal axis of said centerbar; and
(b) said at least one centerbar comprises two centerbars disposed between said side frame members in spaced-apart relationship with respect to each other and engaging said top frame member and said bottom frame member.

19. The air return grille of claim 18 comprising at least two filter retainers provided on said frame for receiving and mounting the filter on said frame.

20. The air return grille of claim 19 comprising at least two sets of retainer clips mounted on said frame and at least one leg retainer provided on each of said retainer clips for removably receiving said filter retainers, respectively, and removably mounting the filter on said frame.

21. The air return grille of claim 20 wherein said at least one leg retainer comprises two leg retainers provided in spaced-apart relationship with respect to each other on said retainer clips, respectively, for selectively receiving said filter retainers and removably mounting the filter on said frame.

22. An air return grille for seating in an air return opening and mounting at least one filter, said air return grille comprising a frame defined by a pair of side frame members, a top frame member spanning one end of said side frame members and a bottom frame member spanning the opposite end of said side frame members; a plurality of inwardly-facing, spaced-apart slat seats provided in said side frame members; at least one centerbar disposed between said side frame members and engaging said top frame member and said bottom frame member; a plurality of spaced-apart slat openings provided in said centerbar, said slat openings disposed in substantially coplanar relationship with corresponding ones of said slat seats in said side frame members; a plurality of slats extending in a slip-fit through said slat openings in said centerbar, with the ends of said slats tightly seated in said slat seats in said side frame members; at least two filter retainers provided on said frame for receiving and mounting the filter on said frame; and at least one pair of seating brackets provided on said frame and a pair of seating screws provided in said air return opening, with said frame removably seated in said air return opening in a friction-fit, responsive to contact between said seating brackets and said seating screws.

23. The air return grille of claim 22 wherein said at least one centerbar comprises two centerbars disposed between said side frame members in spaced-apart relationship with respect to each other and engaging said top frame member and said bottom frame member.

24. The air return grille of claim 23 wherein said slat seats are disposed at a first selected angle with respect to the longitudinal axis of said side frame members and said slat openings are disposed at said first selected angle with respect to the longitudinal axis of said centerbar.

25. The air return grille of claim 24 comprising at least two sets of retainer clips mounted on said frame and at least one leg retainer provided on each of said retainer clips for removably receiving said filter retainers, respectively, and removably mounting the filter on said frame.

26. The air return grille of claim 25 wherein said at least one leg retainer comprises two leg retainers provided in spaced-apart relationship with respect to each other on said retainer clips, respectively, for selectively receiving said filter retainers and removably mounting the filter on said frame.

27. An air return grille for seating in an air return opening and mounting at least one filter, said air return grille comprising a frame defined by a pair of side frame members, a top frame member spanning one end of said side frame members and a bottom frame member spanning the opposite end of said side frame members; a plurality of inwardly-facing, spaced-apart, substantially parallel slat seats provided in said side frame members; at least one centerbar disposed between said side frame members and engaging said top frame member and said bottom frame member; a plurality of spaced-apart, substantially parallel slat openings provided in said centerbar, said slat openings disposed in substantially coplanar relationship with corresponding ones of said slat seats in said side frame members; a plurality of slats extending through said slat openings in said centerbar, with the ends of said slats tightly seated in said slat seats in said side frame members; at least two filter retainers provided on said frame for receiving and mounting the filter on said frame; at least two sets of retainer clips attached to said frame and at least one leg retainer provided on each of said retainer clips for removably receiving said filter retainers, respectively, and removably mounting the filter on said frame; and at least one pair of seating brackets provided on said frame and a pair of seating screws provided in said air return opening, with said frame removably seated in said air return opening in a friction-fit, responsive to contact between said seating brackets and said seating screws.

28. The air return grille of claim 27 wherein said at least one leg retainer comprises two leg retainers provided in spaced-apart relationship with respect to each other on said retainer clips, respectively, for selectively receiving said filter retainers and removably mounting the filter on said frame.

29. The air return grille of claim 27 wherein said at least one centerbar comprises two centerbars disposed between said side frame members in spaced-apart relationship with respect to each other and seated on said top frame member and said bottom frame member.

30. The air return grille of claim 27 wherein:
(a) said at least one leg retainer comprises two leg retainers provided in spaced-apart relationship with respect to each other on said retainer clips, respectively, for selectively receiving said filter retainers and removably mounting the filter on said frame; and
(b) said at least one centerbar comprises two centerbars disposed between said side frame members in spaced-apart relationship With respect to each other and seated on said top frame member and said bottom frame member.
